(19) United States
(12) Patent Application Publication
(10) Pub. No.: US 2019/0205172 A1
(43) Pub. Date: Jul. 4, 2019

(54) COMPUTER-IMPLEMENTED METHODS AND SYSTEMS FOR OPTIMAL PLACEMENT AND EXECUTION OF SOFTWARE WORKLOADS IN A GEOGRAPHICALLY DISTRIBUTED NETWORK OF COMPUTE NODES

(71) Applicant: Alan Arolovitch, Brookline, MA (US)

(72) Inventor: Alan Arolovitch, Brookline, MA (US)

(21) Appl. No.: 16/172,419

(22) Filed: Oct. 26, 2018

Related U.S. Application Data
(60) Provisional application No. 62/577,453, filed on Oct. 26, 2017.

(51) Int. Cl. G06F 9/50; H04L 29/08

(52) U.S. Cl. CPC G06F 9/505; H04L 67/1008; H04L 67/327; H04L 67/1023; H04L 67/322; H04L 67/1021

(57) ABSTRACT

Computer-implemented methods and systems are disclosed for optimally placing and executing software workloads in a geographically distributed network of compute nodes.

### RELATED APPLICATION

This application claims priority from U.S. Provisional Patent Application No. 62/577,453 filed on Oct. 26, 2017 entitled COMPUTER-IMPLEMENTED METHODS AND SYSTEMS FOR OPTIMAL PLACEMENT AND EXECUTION OF SOFTWARE WORKLOADS IN A GEOGRAPHICALLY DISTRIBUTED NETWORK OF COMPUTE NODES, which is hereby incorporated by reference.

### BACKGROUND

The present application relates generally to placement of compute workloads within geographically distributed networks of compute nodes, e.g., public clouds, private clouds, edge computing networks, and others.

The Internet today is designed for predominantly centralized data processing and subsequent distribution of immutable content to endpoints. The networks today are designed and provisioned for downstream data distribution from the center to the edge, at the expense of upstream capacity.

The proliferation of devices capable of producing massive amounts of data has created a disbalance where a lot of data is produced in a highly distributed fashion breaking the centralized processing model.

Oftentimes, there is not enough network capacity to bring the data to the centralized compute resources. Even if there is enough network capacity, the latency incurred by data movement is too high.

Additionally, massive, geographically distributed public and private data stores have sprung up around the globe, including consumer and enterprise file sharing services, content delivery networks (CDNs), digital archives and more. Running data-oriented computational tasks, such as indexing, filtering, analytics, and others, in centralized locations against these data stores is impractical due to bandwidth constraints.

### BRIEF SUMMARY

In accordance with one or more embodiments, a computer-implemented method is provided for optimally placing and executing software workloads in a geographically distributed network of compute nodes.

A method in accordance with one or more embodiments includes the steps of:

(a) receiving a request for a software workload execution;

(b) identifying the best possible compute node(s) within the compute network to handle this request;

(c) sending a request for same software workload execution to the selected compute node(s);

(d) provisioning the requested software workload for execution at the node(s)

(e) executing the software workload at the at the compute node(s) in a way that isolates the workload from other software workloads on the same node(s)

(f) responding to the request with the workload execution outcome

In accordance with one or more embodiments, a service is provided for optimal execution of software workloads in a geographically distributed network of compute nodes.

The service is configured to:

(a) receive a request for software workload execution

(b) identify at least one best possible compute node within the compute network to handle this request

(c) send a request for execution of the software workload to the selected compute node(s)

(d) provision the requested software workload(s) for execution at such node(s)

(e) execute the software workload at the compute node(s), in a way that isolates the workload from other software workloads on the same node

(f) responding to the request with the workload execution outcome

### BRIEF DESCRIPTION OF THE DRAWINGS

FIG. 1 is a flow diagram illustrating an exemplary process for handling a request for software workload execution in accordance with one or more embodiments.

FIG. 2 is a simplified diagram illustrating deployment of an exemplary cloud service for handling a request for software workload execution in accordance with one or more embodiments

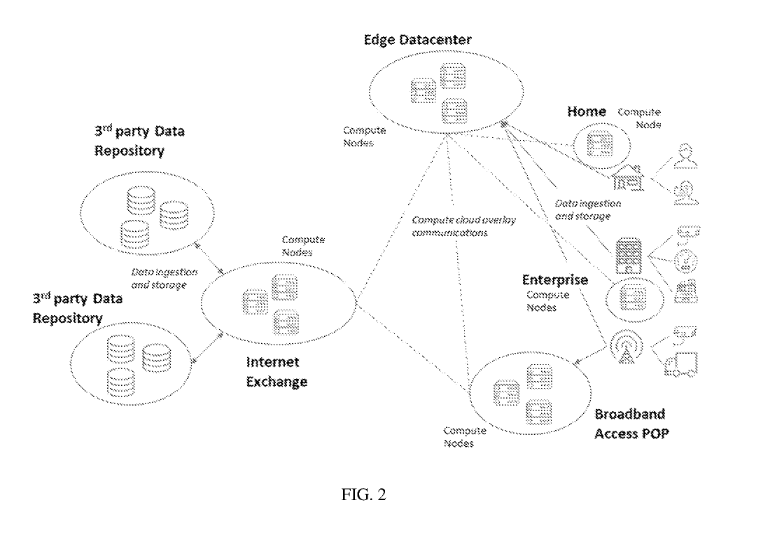

### DETAILED DESCRIPTION

Various embodiments disclosed herein relate to a service for optimal execution of software workloads in a geographically distributed cloud, based on requests received by a service for optimal execution of software workloads.

As used herein the “service” refers to a service allowing execution of software workloads by one or more parties, whereby the party using the service provides the workload to the service together with optional configuration and information pertaining to how the workload is to be executed. The user utilizes the service using Web portal, programmatic application programming interface (API), specialized client tools, or a combination thereof.

The service may provide service level agreements (SLAs) around the workload execution, reporting and analytics, and other features and functionality pertaining to the workload execution.

According to one or more embodiments, the service can be implemented as a public cloud service available to all Internet-connected users, utilizing cloud nodes shared by different users; as a private cloud service available to users who belong to the same organization as the service operator; as a hybrid cloud service combining both public cloud nodes and private cloud nodes; as a value-added service offered in conjunction with other services, including but not limited to: hosting and colocation, content delivery, streaming video delivery, IoT network access, broadband access, managed cloud, managed application delivery, managed security;

As used herein, the term “cloud node” refers to any device participating in the service business logic execution and being connected to an IP-based network including, without limitation, computer servers, personal computers, set-top boxes, smart phones, and other network connected devices.

As used herein, the term “cloud” refers to an overlay network of cloud nodes, connected over an IP-based network, and jointly executing the service business logic.

As used herein, the term “compute node” refers to a cloud node capable of executing at least one form of software workloads.

As used herein, the term “data object” refers to any form of computer data that is made available to the compute nodes over the IP-based network, either using data object identifier or as part of the request for software workload execution, and are used by the software workload during its execution

Examples of data objects include, but are not limited to: a video or image recorded by the user; structured information in a known data format like XML, JSON, or other format uploaded by the user; a database record; an object stored in an object store; any object or stream available from 3rd party Web server, CDN, or other Web service; any other streaming or static data set that is uploaded to the service or can be retrieved from an external IP-connected data source.

The IP-connected devices making data objects available to the service are referred to herein as “data sources.”

As used herein, the term “user” refers to any party authorized to request execution of software workloads in the system.

As used herein, the term “tenant” refers to any party provisioning software workloads for execution to the system.

As used herein, the term “operator” refers to the party managing and operating the service.

The service operates across plurality of jointly orchestrated and managed cloud nodes, where some of them are also compute nodes, i.e., nodes capable of executing software workloads.

As used herein, the term “software workload” refers to any form of executable software including, but not limited to, machine executable code executed by hardware processor, bytecode processed by virtual machine, source code in an interpreted programming language, container or VM image executed by specialized virtualization engine, or source code and build instructions for producing machine executable code.

Examples of software workload services to be executed by the service include, but are not limited to: network services; Web applications serving requests from Web clients; API gateways; IoT gateways and IoT applications serving requests and/or processing data from IoT devices, such as sensors, wearables, cameras, drones, autonomous vehicles and others; computational-intensive batch processing; data indexing; data analytics; machine learning and artificial intelligence; video and image encoding and transcoding;

According to one or more embodiments, the compute nodes are located in proximity to known locations of data sources and/or service users including, but not limited to, a network point-of-presence (POP) with cloud storage facilities; edge data centers; enterprise data centers; broadband access networks connecting Internet of things (IoT) devices to the Internet—wireline, wireless, satellite or other; Internet exchanges (IXs) and other network peering facilities; edge POPs within broadband access network.

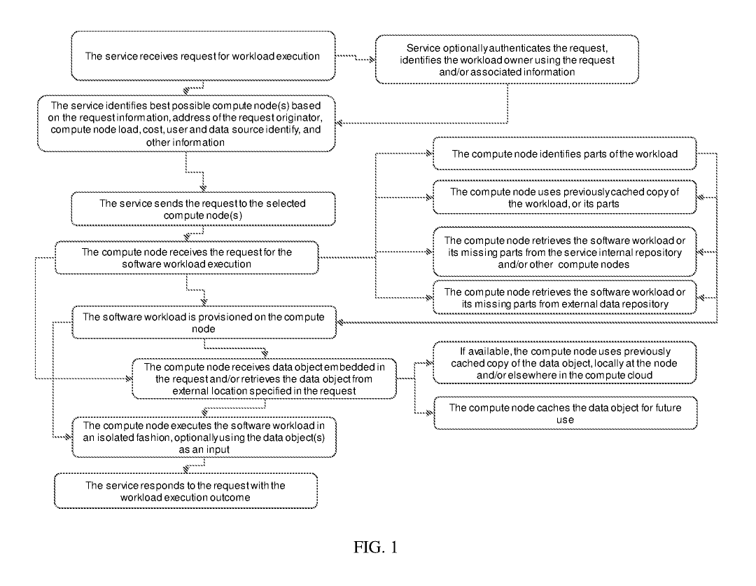

As shown in FIG. 1, the request for software workload execution is received by the service. The request can be initiated by any device, connected to an IP-based network including, without limitation, devices belonging to external cloud networks, CDNs, Web services, personal computers, IoT devices as well as cloud nodes that are part of the service itself.

The request for software workload execution can be implemented using any form of data communication over IP-based network, including but not limited to HTTP, SSL, DNS protocols, and use various forms of IP routing between IP-connected nodes, including but not limited to unicast, multicast, broadcast and anycast.

The request may specify one or more data objects to be used as input for the software workload execution by providing either identification of the data object(s), which can be used by the service to access it, such as HTTP URI, or the data object itself. Such identification may optionally include credentials required for authorized access of the data.

The request may optionally include credentials required for authorized access to software repositories and/or specific compute nodes.

According to one or more embodiments, the compute node starts the software workload execution starts just in time as one or more data objects are received from the data source. The compute node may receive the data object(s) as part of the original request for execution or retrieve the data object(s) from an external data source using the information provided in the request and/or service configuration.

The request may optionally include additional data pertaining to the data object(s) and/or request such as, without limitation, information about data or metadata change, data item access, a system event such as a change in resource availability or capacity, scheduled execution, a processing event such as success or failure of another piece of software, or certain external event such as arrival of an e-mail or a signal, or a call to an application programming interface (API).

As illustrated in FIG. 1, the service receives the request for the software workload identification. According to one or more embodiments, the request includes an explicit software workload identification including, but not limited to, a unique Uniform Resource Identifier (URI) identifying the workload within the service, the URI of workload within public software repository like GitHub, CDN, or object storage service.

In some cases, the identification relates to a workload previously provisioned at the service. In other cases, the service acquires the software workload from an external data source using the identification provided in the request.

In the absence of such explicit software workload identification, the service may identify the software workload that needs to be executed using the information provided in the request as well as configuration or other heuristics previously provided to it by its tenants and/or operators.

According to one or more embodiments, the precise workload identification is done prior and/or in parallel to selecting the compute node(s) and affects that selection. According to other embodiments, the precise workload identification can be left to the selected compute node(s).

According to one or more embodiments, the service identifies multiple software workloads associated with same request, that are executed in series and/or in parallel, in one or many compute nodes. Furthermore, the service may initiate parallel execution of the software workload in multiple compute nodes and use only such outcomes of the execution that conclude fastest.

As shown in FIG. 1, after receiving the request, the service selects the most optimal compute node(s) for execution of the software workload.

Such selection considers at least one of the following factors:

(a) network or geographical proximity from the compute to node to the data source;

(b) availability of a cached data object at the compute node or its adjacent nodes;

(c) end-to-end workload completion time that includes data access and compute completion times;

(d) current and/or expected compute load of compute node;

(e) cost of network and/or data source access;

(f) workload placement policies put in place by service tenants and/or operators;

(g) service level agreements (SLAs) or application requirements pertaining to latency, associated with the workload and/or particular request;

(h) location of the compute node and/or data source within particular geographical, political or administrative boundaries for legal compliance purposes;

(i) user and/or tenant identity, associated service levels and other attributes; and

(j) IP address and/or network identity, such as BGP (Border Gateway Protocol) autonomous system number (ASN) of the user and/or data source.

The selection function can be performed by the service using dedicated cloud node(s) that are tasked with forwarding the request to compute nodes, or by compute nodes that are also capable of executing the software workloads.

The selection can be further performed in several steps, in series and/or in parallel, e.g., whereby a group of nodes is selected initially, and subsequently more granular node selection is performed by the nodes within the group.

According to one or more embodiments, the service may implement complex node selection schemes, whereby groups of nodes arrive to distributed consensus on node selection and/or individual node may bid for requests and/or nodes may refuse assignment, causing re-selection.

As illustrated in FIG. 1, the service provisions the software workload for execution on the node. The compute node retrieves the software workload in one or several ways described below:

(a) using a copy of the software workload previously cached at the node;

(b) retrieving it from dedicated repository within the service;

(c) retrieving it from one or multiple compute nodes that form a distributed repository; or

(d) retrieving it from external data source, as indicated in the request or identified by the service.

According to one or more embodiments, the compute node caches parts of workloads as follows:

(a) uniquely identifying parts of workload, e.g., Docker containers consisting of multiple layers, each having its own unique hash identifier;

(b) storing at least some of workload parts for future use (e.g. operating system layer, Python runtime etc.);

(c) retrieving the missing workload parts from external source(s); or

(d) combining the cached and newly retrieved parts of the workload for execution.

The compute node may further implement caching business logic whereby it chooses to store and remove the software workload parts, taking into account temporal characteristics like most recent time of use, frequency of use or other popularity metric, characteristics pertaining to workload type, workload size, workload part size and others, or combination thereof.

As illustrated in FIG. 1, the steps of software workload identification and compute node selection can be executed sequentially or in parallel.

As illustrated in FIG. 1, after the node selection is completed, the steps of software workload and data object provisioning can be executed sequentially or in parallel. Additionally, the software workload execution may start before and/or in parallel to the data object provisioning.

In accordance with FIG. 1, upon selection of the compute node and provisioning of the software workload on it, an execution of the software workload starts in at least one compute node. The execution is triggered by the compute node receiving a request for software execution.

Such request may be the original request received by the service, or modified and optionally enhanced request, that may include additional information pertaining to the software workload, data object(s), or tenant including, but not limited to:

(a) execution constraints in terms of resources, scheduling, priorities;

(b) isolation and data protection requirements; and

(c) placement and destination specification for the processing results.

Alternatively, the compute node may determine the above information using other configuration and policy mechanisms available to it within the service.

The software workload and isolation and data protection requirements determine the isolation method used for the request execution. Isolation methods may include, but are not limited to, the following:

(a) Runtime environment based isolation where workload is executed in a shared runtime environment and the isolation of code and data is provided by the runtime environment itself. An example of a runtime environment is a Java Virtual Machine (JVM), or a Chromium V8 engine-based server(s) like node.js.

(b) Process-based isolation where each workload is executed in a separate process. The node operating system guarantees isolation of the data and user space code from other processes. Processes share OS kernel and file and networking namespaces. Processes running in parallel compete for memory and CPU resources on the host. An example of a process is a language interpreter such as Python or Perl, a binary executable generated from a source code in a language like C or Go, or a runtime environment as specified in (a) immediately above.

(c) User/group-based isolation that allows stricter control over shared file namespace by restricting access to certain files and/or directories to certain users and groups. In this model, each workload may be running under separate OS user credentials, thus preventing others from accessing local (temporary) files.

(d) Container-based isolation, that allows for complete separation of file and networking namespaces, while still sharing the OS kernel. Container-based isolation may provide better resource separation guarantees, as well as tighter security. An example of a container-based solution is an LXC/LXD or Docker containers.

(e) Hypervisor-based isolation where each workload is running in its own virtual machine. While providing the highest possible level of isolation within a host, this method also has the highest overhead and may significantly increase the cost. An example of a hypervisor is a KVM or Xen.

An engine for execution of third-party cloud software workloads, such as Amazon AWS Greengrass or Microsoft Azure IoT Edge.

Depending on data availability, the compute node engine may need to pull data needed for requested processing, or establish connection with and/or streaming from a data source or sources as a prerequisite for the execution.

Depending on the type of the requested workload, some components and/or runtime libraries may need to be downloaded and stored locally by the node compute engine as a prerequisite for the execution.

Depending on the type of the requested workload, a compilation of the source code and/or re-compilation/optimization of bytecode may be required as a prerequisite for execution.

Upon selection of the isolation method and fulfillment of necessary prerequisites, the compute engine initiates the workload execution process. According to one or more embodiments, some of the pre-requisites may be completed during software workload execution, e.g., full retrieval of the data object, loading of software workload parts and components and other.

The isolation policies can be further carried out by:

(a) tenant identity

(b) data source identity

(c) user identity

(d) data object identity and other attributes, such as local availability

(e) service levels or other attributes associated with tenant, data source and/or user

As a result, multiple software workloads can be executed jointly or in a fully isolated fashion depending on the above information.

Execution of the workload request may result in a success or a failure. The execution outcomes, including but not limited the status of the execution, execution output and other data are communicated back to the user. Completion of execution and/or specific status value may generate subsequent event(s) that may result in new processing requests.

Request execution may result in generation or computation of data. The processing request and/or service configuration may specify where such data (if any) should be delivered and stored upon completion.

Delivery and/or storing of said data may generate subsequent event(s) that may result in new processing requests.

In addition to isolation method, the data protection requirements may determine the faith of the data that may be ingested or generated during the request processing. The data may be ingested from a data source and stored temporarily in node-local scratch storage. Request processing results and temporary data may also be stored in node-local scratch storage.

If the data protection requirements allow that, said temporarily stored data may be retained by the node beyond completion of the request processing and subsequently (re-)used as data cache for similar processing requests.

Availability of cached data and/or capacity and utilization of the scratch storage may be used to determine the optimal placement for subsequent processing requests. For example, if a node A has a higher data transfer latency from a data source than a node B, a node A may still be preferred for execution of a subsequent processing request for the data from said data source if node A has a significant portion of required data in local cache.

The compute node engine collects and stores execution time statistics and/or metrics for different workload types, resource availability and data proximity. Such statistics and/or metrics may be used subsequently by the node for scheduling and/or providing latency and cost estimates for similar requests in the future. Such statistics and metrics may also be delivered to the requestor alongside with the execution status, and/or stored in a repository shared by/available to multiple nodes.

The processes described above may be implemented in software, hardware, firmware, or any combination thereof. The processes are preferably implemented in one or more computer programs executing on a programmable device including a processor, a storage medium readable by the processor (including, e.g., volatile and non-volatile memory and/or storage elements), and input and output devices. Each computer program can be a set of instructions (program code) in a code module resident in the random-access memory of the device. Until required by the device, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A computer-implemented method for optimally placing and executing software workloads in a geographically distributed network of compute nodes, comprising the steps of:
(a) receiving a request for a software workload execution;
(b) identifying one or more compute nodes within the distributed network of compute nodes to handle this request based on a predetermined set of one or more criteria;
(c) sending the request for execution to the one or more compute nodes;
(d) provisioning the requested software workload for execution at the one or more nodes;
(e) executing the software workload at the one or more compute nodes to generate a workload execution outcome, wherein the software workload is executed in a way that isolates the software workload from other software workloads on the one or more nodes; and
(f) responding to the request with the workload execution outcome.

2. The method of claim 1, wherein the request sent in (c) is identical to the request received in (a).

3. The method of claim 1, wherein the software workload is associated with a data object, and wherein the predetermined set of one or more criteria includes: (a) network or geographical proximity from the one or more compute nodes to a party requesting the software workload execution; (b) availability of a cached data object at the one or more compute nodes or adjacent nodes; (c) end-to-end workload completion time that includes data access and compute completion times; (d) a location of the one or more compute nodes and/or a data source for the data object within particular geographical, political or administrative boundaries for legal and/or business policy compliance purposes; or (e) an IP address and/or a network identity of a user and/or the data source associated with the software workload.

4. The method of claim 1, wherein the predetermined set of one or more criteria includes: (a) network or geographical proximity from the one or more compute nodes to a party requesting the software workload execution; (b) current and/or expected compute load of the one or more compute nodes; (c) cost of network and/or data source access; (d) workload placement policies put in place by system tenants and/or operators; (e) service level agreements (SLAs) or application requirements pertaining to latency associated with the software workload and/or the request; or (f) user and/or tenant identity, associated service levels and other attributes.

5. The method of claim 1, wherein the software workload is associated with a data object, and wherein the method further comprises caching the data object or parts thereof at one or more compute nodes for use in subsequent software workload requests.

6. The method of claim 1, further comprising caching the software workload or parts thereof at one or more compute nodes for use in subsequent software workload requests.

7. The method of claim 6, wherein the one or more compute nodes cache parts of workloads by (a) uniquely identifying parts of workload, (b) storing at least some of the parts of the workload for future use, (c) retrieving any missing workload parts from one or more external sources, and (d) combining the cached and retrieved missing workload parts for execution.

8. The method of claim 1, wherein the software workload is isolated from other software workloads on the one or more nodes using one or more of the following isolation techniques: (a) runtime environment based isolation; (b) process-based isolation; (c) user/group-based isolation; (d) container-based isolation; (e) Hypervisor-based isolation; and (f) an engine for execution of third-party cloud software workloads.

9. A computer-implemented service for optimally placement and execution of software workloads in a geographically distributed network of compute nodes, wherein the service is configured to:
(a) receive a request for a software workload execution;
(b) identify one or more compute nodes within the distributed network of compute nodes to handle this request based on a predetermined set of one or more criteria;
(c) send the request for execution to the one or more compute nodes; and
(d) provision the requested software workload for execution at the one or more nodes;
wherein the software workload is executed at the one or more compute nodes to generate a workload execution outcome, wherein the software workload is executed in a way that isolates the software workload from other software workloads on the one or more nodes; and wherein the one or more compute nodes respond to the request with the workload execution outcome.

10. The service of claim 9, wherein the request sent in (c) is identical to the request received in (a).

11. The service of claim 9, wherein the software workload is associated with a data object, and wherein the predetermined set of one or more criteria includes: (a) network or geographical proximity from the one or more compute nodes to a party requesting the software workload execution; (b) availability of a cached data object at the one or more compute nodes or adjacent nodes; (c) end-to-end workload completion time that includes data access and compute completion times; (d) a location of the one or more compute nodes and/or a data source for the data object within particular geographical, political or administrative boundaries for legal and/or business policy compliance purposes; or (e) an IP address and/or a network identity of a user and/or the data source associated with the software workload.

12. The service of claim 9, wherein the predetermined set of one or more criteria includes: (a) network or geographical proximity from the one or more compute nodes to a party requesting the software workload execution; (b) current and/or expected compute load of the one or more compute nodes; (c) cost of network and/or data source access; (d) workload placement policies put in place by system tenants and/or operators; (e) service level agreements (SLAs) or application requirements pertaining to latency associated with the software workload and/or the request; or (f) user and/or tenant identity, associated service levels and other attributes.

13. The service of claim 9, wherein the software workload is associated with a data object, and wherein the data object or parts thereof are cached at one or more compute nodes for use in subsequent software workload requests.

14. The service of claim 9, wherein the software workload or parts thereof are cached at one or more compute nodes for use in subsequent software workload requests.

15. The service of claim 14, wherein the one or more compute nodes cache parts of workloads by (a) uniquely identifying parts of workload, (b) storing at least some of the parts of the workload for future use, (c) retrieving any missing workload parts from one or more external sources, and (d) combining the cached and retrieved missing workload parts for execution.

16. The service of claim 9, wherein the software workload is isolated from other software workloads on the one or more nodes using one or more of the following isolation techniques: (a) runtime environment based isolation; (b) process-based isolation; (c) user/group-based isolation; (d) container-based isolation; (e) Hypervisor-based isolation; and (f) an engine for execution of third-party cloud software workloads.
